(19) United States
(12) Patent Application Publication
(10) Pub. No.: US 2026/0238749 A1
(43) Pub. Date: Aug. 13, 2026

(54) DYNAMIC DEPTH

(71) Applicant: QUALCOMM Incorporated, San Diego, CA (US)

(72) Inventor: Jamie Menjay LIN, San Diego, CA (US)

(21) Appl. No.: 19/049,641

(22) Filed: Feb. 10, 2025

(51) Int. Cl. H04N 13/271; B60R 1/31; H04N 13/00; H04N 13/243

(52) U.S. Cl. CPC H04N 13/271; B60R 1/31; H04N 13/243; H04N 2013/0081

(57) ABSTRACT

Aspects relate generally to providing stereo vision by a device, and more particularly, to utilizing dynamic depth by dynamically switching between full and reduced searches to provide stereo vision of an object. A device may include one or more memories configured to store one or more image frames. The device may further include one or more processors coupled to the one or memories, in which, the one or more processors are configured to: determine an object by user direction or by an automatic region of interest (ROI) selection; switch from a full search of a pre-defined search range of pixels, of image frames, of the object to a reduced search of a reduced range of pixels, of image frames, of the object; and based upon the reduced search, provide stereo vision of the object.

### TECHNICAL FIELD

The technology discussed below relates generally to providing stereo vision by a device, and more particularly, to utilizing dynamic stereo depth estimation by dynamically switching between full and reduced searches.

### INTRODUCTION

Stereo vision may be defined as the ability to perceive depth and spatial information by using two images of the same scene from slightly different perspectives. It is based on the idea that humans have two eyes that see the world from slightly different positions, and the brain combines these views to create a three-dimensional sensation. Stereo video or pictures may be achieved using two views, e.g., a left view and a right view. In order to simulate a human vision system, which has depth perception, a device with two camera sensors may capture left eye and right eye views. In stereo vision, there is disparity in the distance between corresponding points in the two images taken from the slightly different positions of the two camera sensors having left and right views. A stereo image may be created by a device by combing the two images from the left and right camera sensors.

Stereo depth estimation may be defined as a computer vision technique that uses images from two cameras to calculate the depth of objects in a scene by measuring the “disparity” or difference in pixel positions between the two images, essentially recreating the 3D perception of distance based on the slight difference in perspective between the two viewpoints. Stereo depth estimation utilized by devices is a critical computer vision task, supporting various use cases for mobile cameras, extended reality (XR), 3D Robotics (3DR), automobiles, etc.

However, standard algorithms currently used for stereo depth estimation utilize a fixed disparity range that is pre-defined and within which the stereo depth algorithm performs certain energy-based cost searches to find minimum costs for stereo matches. These types of algorithms, although straightforward, do not fully exploit possibilities to optimize the computation in terms of the search range. Further, by always searching for the full range of disparity hypotheses, such algorithms may lose the focus on finer windows of details. Moreover, these types of algorithms repeat their search over the same or similar range of hypotheses, wasting resources in computation and memory without necessarily achieving higher accuracy and/or efficiency. These types of algorithms restrict the configurability of stereo depth estimation operation with respect to the dynamics of different scenarios and conditions.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a device is provided. The device may include one or more memories configured to store one or more image frames and one or more processors coupled to the one or memories. The one or more processors may be configured to: determine an object by user direction or by an automatic region of interest (ROI) selection; switch from a full search of a pre-defined search range of pixels, of image frames, of the object to a reduced search of a reduced range of pixels, of image frames, of the object; and based upon the reduced search, provide stereo vision of the object.

Another example is a method for providing stereo vision of an object. The method includes: determining an object by user direction or by an automatic region of interest (ROI) selection; switching from a full search of a pre-defined search range of pixels, of image frames, of the object to a reduced search of a reduced range of pixels, of image frames, of the object; and based upon the reduced search, provide stereo vision of the object.

In yet another example, a non-transitory computer-readable data storage medium is provided that has stored thereon instructions that, when executed, cause one or more processors to: determine an object by user direction or by an automatic region of interest (ROI) selection; switch from a full search of a pre-defined search range of pixels, of image frames, of the object to a reduced search of a reduced range of pixels, of image frames, of the object; and based upon the reduced search, provide stereo vision of the object.

These and other aspects will become more fully understood upon a review of the detailed description, which follows. Other aspects, features, and examples will become apparent to those of ordinary skill in the art, upon reviewing the following description of examples in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. In similar fashion, while exemplary examples may be discussed below as device, system, or method examples such exemplary examples can be implemented in various devices.

### BRIEF DESCRIPTION OF THE DRAWINGS

FIG. 1 is a diagram illustrating an example of a device according to some aspects.

FIG. 2 is a flowchart illustrating an example of a process to provide stereo vision by a device utilizing dynamic stereo depth estimation that dynamically switches between full and reduced searches according to some aspects.

FIG. 3A is a diagram illustrating an example of a full hypothesis search (FHS) according to some aspects.

FIG. 3B is a diagram illustrating an example of a reduced hypothesis search (RHS) according to some aspects.

FIG. 3C is a diagram illustrating an example of Open Fast Disparity Tracking (O-FDT) according to some aspects.

FIG. 3D is a diagram illustrating an example of Closed Fast Disparity Tracking (C-FDT) according to some aspects.

FIG. 4 is a flowchart describing dynamically switching between full and reduced searches according to some aspects.

FIG. 5 is a diagram illustrating an example of a device according to some aspects.

FIG. 6 is a diagram example of a scenario where the device is a mobile device according to some aspects.

FIG. 7 is a diagram example of a scenario where the device is a vehicle driving towards an object according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Aspects of the disclosure generally relate to providing stereo vision by a device, and more particularly, to utilizing dynamic stereo depth estimation by dynamically switching between full and reduced searches. The device may include one or more memories configured to store one or more image frames and one or more processors coupled to the one or memories. The one or more processors may be configured to: determine an object by user direction or by an automatic region of interest (ROI) selection; switch from a full search of a pre-defined search range of pixels, of image frames, of the object to a reduced search of a reduced range of pixels, of image frames, of the object; and based upon the reduced search, provide stereo vision of the object.

Therefore, based upon a dynamic depth stereo estimation solution (hereinafter referred to as a dynamic depth (DD) solution), limitations of traditional stereo depth estimation algorithms are addressed by switching from a full search to a reduced search. In particular, as will be described in more detail hereafter, a novel approach is described that dynamically switches between a Full-Hypothesis Search (FHS) and a Reduced-Hypothesis Search (RHS) based on probabilistic evaluations of current and past frames. Further, as will be described in more detail hereafter, the aspects related to DD implementations also incorporate Fast Disparity Tracking (FDT) methods, including Open FDT (O-FDT) and Closed FDT (C-FDT), to optimize computation and improve accuracy. The FDT method, as will be described in more detail hereafter, tracks the disparity hypotheses with a great reduction in computational costs and is an alternative method to the standard disparity hypothesis search. Moreover, as will be described in more detail hereafter, aspects relate to DD implementations to support zooming into specific objects, regions, or depth ranges to further enhance efficiency and precision. These innovative solutions may leverage machine learning-based filters and dynamic search ranges to provide a more efficient and accurate depth estimation.

Therefore, aspects of the disclosure, as will be described in more detail hereafter, utilize dynamic stereo depth estimation by dynamically switching between full and reduced searches in providing stereo vision of an object in a very computationally efficient manner while maintaining high accuracy.

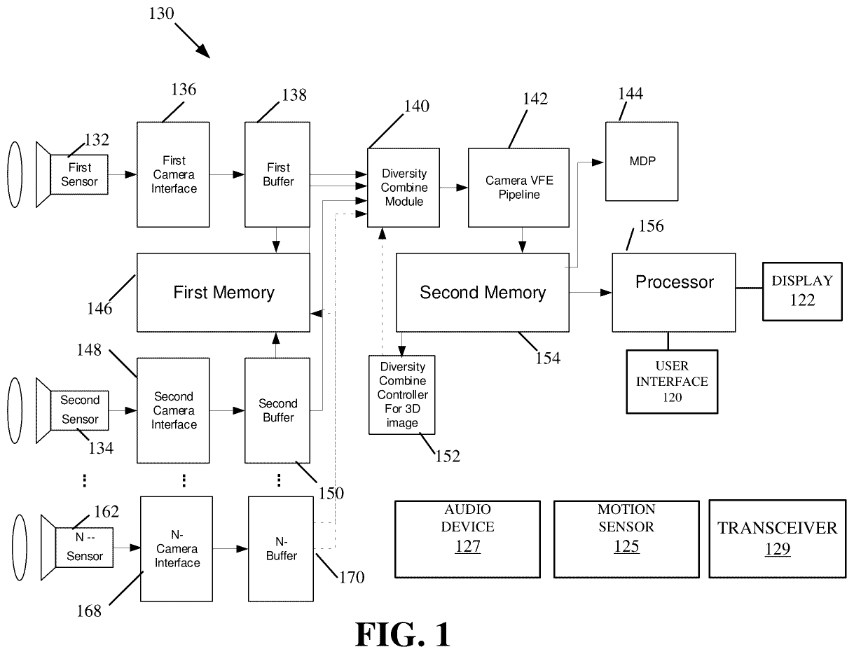

FIG. 1 illustrates a device 130 with multiple digital sensors (first, second . . . N) 132, 134, 162 configured to capture and process 3-D stereo images and videos. It should be appreciated that digital sensors 132, 134, 162 may be camera sensors but that other sorts of sensors may be utilized. Also, device 130 may be a mobile device but also may be a fixed device or another sort of device. In general, device 130 may be configured to capture, create, process, modify, scale, encode, decode, transmit, store, and display digital images and/or video sequences. Device 130 may provide high-quality stereo image capturing, various sensor locations, view angle mismatch compensation, and an efficient solution to process and combine a stereo image.

In one aspect, device 130 may be: a mobile device, a mobile phone, a vehicle, a robot, a stationary Internet of Things (IoT) device, a mobile IoT device, or a security device. However, these devices are just examples and it should be appreciated that device 130 may be any suitable device.

Additionally device 130 may represent or be implemented in a wireless communication device, a personal digital assistant (PDA), a handheld device, a laptop computer, a desktop computer, a digital camera, a digital recording device, a network-enabled digital television, a mobile phone, a cellular phone, a satellite telephone, a camera phone, a terrestrial-based radiotelephone, a direct two-way communication device (sometimes referred to as a “walkie-talkie”), a camcorder, etc.

Device 130 may include a first camera sensor 132, a second camera sensor 134, a N-camera sensor 162, a first camera interface 136, a second camera interface 148, a N-camera interface 168, a first buffer 138, a second buffer 150, a N-buffer 170, a memory 146, a diversity combine module 140 (or engine), a camera process pipeline 142, a second memory 154, a diversity combine controller for 3-D image 152, a mobile display processor (MDP) 144, a processor 156, a user interface 120, a display device 122, a motion sensor 125, an audio device 127, and a transceiver or modem 129. It should be appreciated that motion sensor 125, audio device, and transceiver may also be coupled to processor 156. In addition to or instead of the components shown in FIG. 1, device 130 may include other components. The architecture in FIG. 1 is merely an example. The features and techniques described herein may be implemented with a variety of other architectures.

Device 130 may utilize processor 156 to interact with a plurality of different cameras (N-cameras) (e.g., camera 1 132, camera 2, camera N 162), in which, processor 156 may select a pair of cameras (or multiple cameras) to provide the stereo vision of an object. For example, processor 156 may store image frames to memories (e.g., first memory 146, second memory 154, etc.) from cameras (132, 134, 162, etc.) based upon user selection or device selection. As has been described, device 130 may include one or more memories (e.g., first memory 146, second memory 154, etc.) configured to store one or more image frames including objects, pixels, etc., received from cameras 132, 134, 162, etc.

In one example aspect, processor 156 may be configured to: determine an object by user direction (e.g., through user interface 120 by the user) or by an automatic region of interest (ROI) selection (e.g., by the device itself); switch from a full search of a pre-defined search range of pixels, of image frames, of the object to a reduced search of a reduced range of pixels, of image frames, of the object; and based upon the reduced search, provide stereo vision of the object.

The sensors 132, 134, 162 (N-sensors) may be digital camera sensors. The sensors 132, 134, 162 may have similar or different physical structures. The sensors 132, 134, 162 may have similar or different configured settings. The sensors 132, 134, 162 may capture still image snapshots and/or video sequences. Each sensor may include color filter arrays (CFAs) arranged on a surface of individual sensors or sensor elements.

The memories 146, 154 may be separate or integrated. The memories 146, 154 may store images or video sequences before and after processing. The memories 146, 154 may include volatile storage and/or non-volatile storage. The memories 146, 154 may comprise any type of data storage means, such as dynamic random access memory (DRAM), FLASH memory, NOR or NAND gate memory, or any other data storage technology.

The camera process pipeline 142 (also called engine, module, processing unit, video front end (VFE), etc.) may comprise a chip set for a mobile phone, which may include hardware, software, firmware, and/or one or more microprocessors, digital signal processors (DSPs), application specific integrated circuits (ASICs), field programmable gate arrays (FPGAs), or various combinations thereof. The pipeline 142 may perform one or more image processing techniques to improve quality of an image and/or video sequence.

Processor 156 may include one or more processors and may implement down-sampling/encoding functions and/or up-sampling/decoding functions. Processor 156 may also implement other functions of device 130. Processor 156 may operate as a video encoder and may implement or comprise an encoder/decoder (CODEC) for encoding (or down-sample or compress, etc.) and decoding (or up-sample or decompress) digital video data. As an example, the processor operating to implement video encoder function may use one or more encoding/decoding standards or formats, such as MPEG or H.264. In other examples, separate video encoder and/or video decoder devices may be utilized.

The transceiver or modem 129 may receive and/or transmit coded images or video sequences to another device or a network. The transceiver or modem 129 may use a wireless communication standard, such as code division multiple access (CDMA). Examples of CDMA standards include CDMA 1× Evolution Data Optimized (EV-DO) (3GPP2), Wideband CDMA (WCDMA) (3GPP), etc. In other examples, transceiver or modem 129 may utilize other cellular communication standards, such as 4G, 4G-LTE (Long-Term Evolution), LTE Advanced, 5G, 6G, or the like. In some examples, other wireless standards, such as IEEE 802.11 specification, IEEE 802.15 specification (e.g., ZigBee™), Bluetooth™ standard, or the like, may be utilized.

Device 130 may maintain a fixed horizontal distance between the sensors 132, 134, 162 such that 3-D stereo image and video can be generated efficiently. As shown in FIG. 1, the N-sensors 132, 134, 162 may be separated by a suitable fixed horizontal distance. The first sensor 132 may be a primary sensor, and the second sensor 134 and N-sensor 162 may be secondary sensors. The secondary sensors may be shut off for non-stereo mode to reduce power consumption. However, this is an optional sensor set-up.

The buffers 138, 150, 170 may store real time sensor input data, such as one row or line of pixel data from the sensors 132, 134, 162. Sensor pixel data may enter the small buffers 138, 150, 170 on-line (i.e., in real time) and be processed by the diversity combine module 140 and/or camera engine pipeline engine 142 offline with switching between the sensors 132, 134, 162 (or buffers 138, 150, 170) back and forth. The diversity combine module 140 and/or camera engine pipeline engine 142 may operate at about two times the speed of one sensor's data rate. To reduce output data bandwidth and memory requirement, stereo image and video may be composed in the camera engine 142.

The diversity combine module 140 may first select data from the first buffer 138. At the end of one row of buffer 138, the diversity combine module 140 may switch to the second buffer 150 to obtain data from the second sensor 134 or likewise to the N-buffer 170 to obtain data from the N-sensor 162. The diversity combine module 140 may switch back to the first buffer 138 at the end of one row of data from the second buffer 150 or N-buffer 170.

In order to reduce processing power and data traffic bandwidth, the sensor image data in video mode may be sent directly through the buffers 138, 150, 170 (bypassing the first memory 146) to the diversity combine module 140. On the other hand, for a snapshot (image) processing mode, the sensor data may be saved in the memory 146 for offline processing. In addition, for low power consumption profiles, the second sensor 134 or N-sensor 162 may be turned off, and the camera pipeline driven clock may be reduced.

Aspects of the disclosure generally relate to providing stereo vision by device 130, and more particularly, to utilizing dynamic stereo depth estimation by dynamically switching between full and reduced searches.

As previously described, device 130 may include one or more memories (e.g., first memory 146, second memory 154, etc.) configured to store one or more image frames including objects, pixels, etc., received from cameras 132, 134, 162, etc. Device 130 may include processor 156 configured to: determine an object by user direction (e.g., through user interface 120 by the user) or by an automatic region of interest (ROI) selection (e.g., by the device itself); switch from a full search of a pre-defined search range of pixels, of image frames, of the object to a reduced search of a reduced range of pixels, of image frames, of the object; and based upon the reduced search, provide stereo vision of the object.

As will be described, based upon a dynamic depth stereo estimation solution (hereinafter referred to as a dynamic depth (DD) solution), limitations of traditional stereo depth estimation algorithms are addressed by switching from a full search to a reduced search. In particular, as will be described in more detail hereafter, a novel approach is described that dynamically switches between a Full-Hypothesis Search (FHS) and a Reduced-Hypothesis Search (RHS) based on probabilistic evaluations of current and past frames. Further, as will be described in more detail hereafter, the aspects related to DD implementations also incorporate Fast Disparity Tracking (FDT) methods, including Open FDT (O-FDT) and Closed FDT (C-FDT), to optimize computation and improve accuracy. The FDT method, as will be described in more detail hereafter, tracks the disparity hypotheses with a great reduction in computational costs and is an alternative method to the standard disparity hypothesis search. Moreover, as will be described in more detail hereafter, aspects relate to DD implementations to support zooming into specific objects, regions, or depth ranges to further enhance efficiency and precision. These innovative solutions may leverage machine learning-based filters and dynamic search ranges to provide a more efficient and accurate depth estimation.

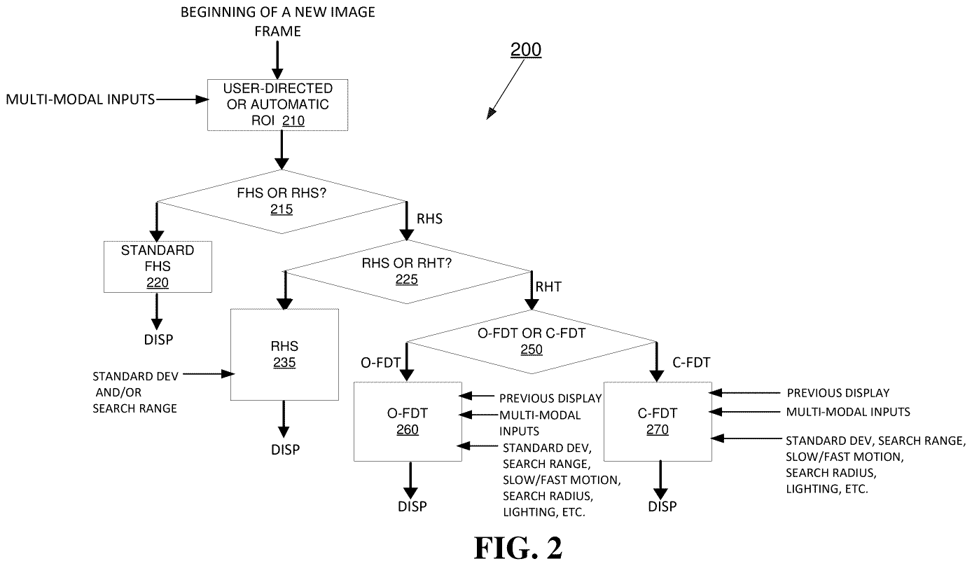

With additional reference to FIG. 2, FIG. 2 is a flowchart illustrating an example of a process 200 to provide stereo vision by a device utilizing dynamic stereo depth estimation that dynamically switches between full and reduced searches, according to one aspect. At block 210, device 130 under the control of processor 156, at the beginning of a new image frame, processor 156 implements process 200 to determine whether to operate in a user-directed mode or in an automatic region of interest (ROI) mode. For example, in the user-directed mode a user may select an object by user direction (e.g., a user may select an object through a user interface 120). As another example, in the automatic ROI mode, device 130 may automatically select an object by an ROI. Examples of different types of objects automatically selected by an ROI by device 130 or by a user will be described hereafter. Also, it should be appreciated that user interface 120 to receive user direction to select an object may be a touchscreen, a keypad, an audio input device, etc. (i.e., any suitable user interface).

Further, in the automatic ROI mode, the automatic ROI selected may be defined by at least one of a region, pixel coordinates, disparity ranges, a semantic class, an object instance, a foreground, or a background. For example, the ROIs may be represented in the form of region/box/pixel coordinates or their corresponding disparity or depth ranges. Also, in some aspects, ROI derivation may implemented by methods, such as, K-means, nearest neighbors, and other learning clustering (e.g., neural networks). Additionally, as will be described in more detail hereafter, multi-modal inputs (in addition to camera inputs) may be used to assist in ROI derivation and/or depth ranging. It should be appreciated that multi-modal inputs may also be utilized in user-directed selection of the object. For example, multi-modal inputs may include: lidar; iToF/dToF; speedometer; Bluetooth; WiFi; 5G; 6G; Ultrasound signals; etc. This is of course a limited list of multi-modal inputs and other types of multi-modal inputs may be utilized. Also, it should be appreciated that device 130 under the control of processor 156 may remove images unrelated to the object in the ROI.

At decision block 215, device 130 under the control of processor 156, implements process 200 to determine whether to switch from a standard full hypothesis search (FHS) to a reduced hypothesis search (RHS) based upon the object-related input that is ROI related or user-selected related. In particular, process 200 determines whether to switch from a standard FHS that includes a pre-defined search range of pixels of image frames of the object (e.g., selected by the user or the automatic ROI) to an RHS that includes reduced range of pixels, of image frames, of the object (e.g., selected by the user or the automatic ROI).

It should be appreciated that the standard static FHS searches the full range of hypotheses, whereas, the RHS search only searches a reduced range of hypotheses. In particular, static processing uses a single type of method. In this example, this single type of method is static FHS. However, aspects herein relate to dynamic switching to enable switching between multiple types of methods.

In one example aspect, FHS at decision block 215 of process 200, is typically selected as a first selection, e.g., as first cold start, and when the device is not certain about what specific sub-range of hypotheses to search for.

However, when process 200 becomes certain about what specific sub-range to search for, such as low frame-to-frame variation in motions, then process 200 may switch from FHS to RHS, at decision block 215, and search for only a reduced range. As will be described, a reduced range via RHS does not only enable lower computation, but also potentially higher accuracy as the range of hypotheses is smaller. It should be appreciated that hypothesis searching is typically utilized to build a cost volume for a range and then find the hypothesis of minimum cost.

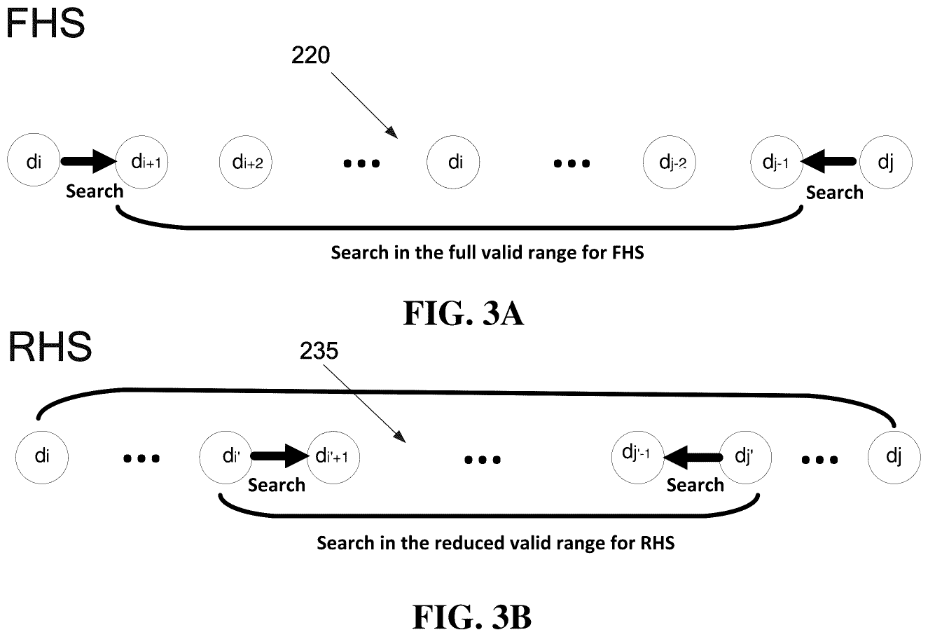

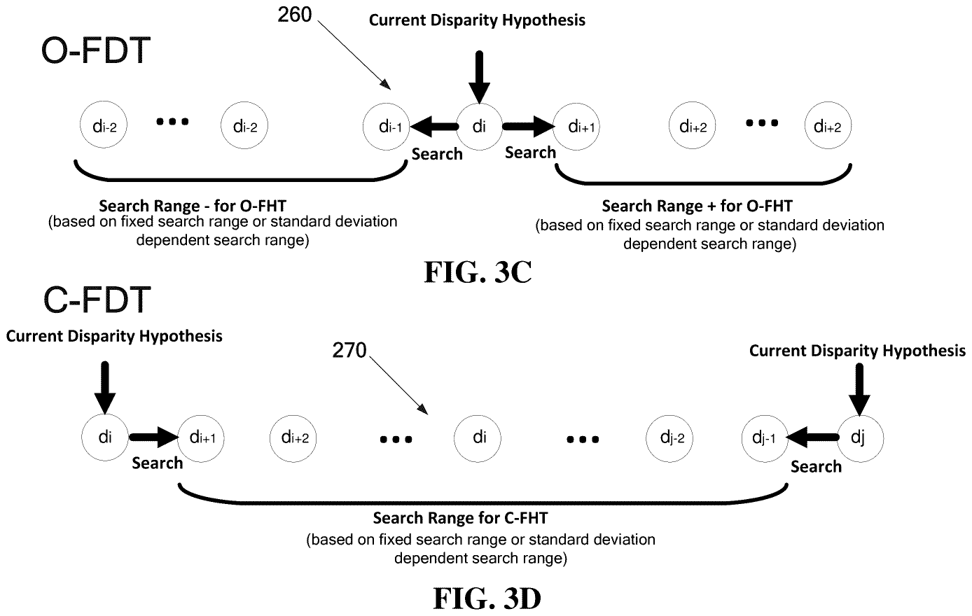

In one example, assuming FHS is selected, at decision block 215, for example, as a first cold start, or, because device 130 is not certain about what specific sub-range of hypotheses to search for, process 200 implements a standard FHS (block 220). With brief references to FIG. 3A, a description of a standard FHS will be provided.

It should be appreciated that a disparity hypothesis in graphics generally refers to an assumption made about the expected difference in pixel positions between two images of the same scene taken from slightly different viewpoints, essentially predicting how much a specific point in the scene will appear shifted between the left and right images (e.g., disparity), which is crucial for calculating depth information in 3D computer vision applications like stereo vision.

In a standard full hypothesis search (FHS) 220, such as shown in FIG. 3A, a disparity hypothesis (dᵢ) for a coordinate pixel (i) is derived based upon a relatively large range of disparity estimations. For example, a large range of possible disparity estimations (e.g., 0 to 192), may be made for coordinate pixel (i). It should be appreciated that pixel (i) corresponds to a pixel of the object of the image frame selected by a user or an automatic ROI selection, as previously described. As shown in FIG. 3A, in FHS 220, a plurality of right disparity estimations may be calculated (dⱼ₋₁, dⱼ₋₂ . . . dⱼ₋ₙ) and a plurality of left disparity estimations may be calculated (dᵢ₊₁, dᵢ₊₂ . . . dᵢ₊ₙ), in order to achieve a final disparity estimation for coordinate pixel (i) defined as dᵢ. Therefore, dᵢ and dⱼ may be used to denote the minimum and maximum disparity in the intended disparity search range. As an example, dᵢ, dⱼ may be (0,192) if minimum and maximum values are 0 to 192 for the range. As has been described, the final disparity estimation for coordinate pixel (i)-(dᵢ)—can be used for the estimated depth/distance information related to the pixel of the object.

This standard static FHS 220 works well as a first selection, e.g., as a first cold start, and when the device is not certain about what specific sub-range of hypotheses to search for. However, the FHS 220, by utilizing a full range of hypotheses that are pre-defined repeats of the relatively same search over the same relatively large range utilizes a relatively large amount of resources in computation and memory. Therefore, as shown in FIG. 2, process 200, based on implementing the standard FHS 220 calculates a final disparity estimation (DISP) for coordinate pixel (i)-(dᵢ).

As has been described, when process 200 becomes certain about what specific sub-range to search for, such as low frame-to-frame variation in motions, then process 200 may switch from FHS to RHS, at decision block 215, and search for only a reduced range. As will be described, a reduced range via RHS does not only enable lower computation, but also potentially higher accuracy as the range of hypotheses is smaller.

In this instance, a RHS search may be implemented. At decision block 225, an RHS 235 may be implemented to determine a final disparity estimation (DISP) for coordinate pixel (i)-(dᵢ). The Reduced-Hypothesis Search (RHS) may be based on probabilistic evaluations of current and past frames. As an example, RHS as part of DD may employ a learned filter (e.g., ML-based) or simple weighted average.

In one example, assuming RHS is selected, at decision block 225, process 200 implements a RHS (block 235). With brief references to FIG. 3B, a description of a RHS will be provided. As shown in FIG. 3B, in RHS 235, a plurality of right disparity estimations may be calculated (d_{j′}, d_{j′-1} . . . ) and a plurality of left disparity estimations may be calculated (d_{i′}, d_{i′+1} . . . ), in order to achieve a final disparity estimation for coordinate pixel (i)—defined as dᵢ. As has been described, the final disparity estimation for coordinate pixel (i)-(dᵢ)—can be used for the estimated depth/distance information related to the pixel of the object.

It should be noted that the Reduced-Hypothesis Search (RHS) is based upon probabilistic evaluations of current and past frames. In particular, the RHS searches a reduced range of hypotheses based upon the current and past frames. As can be seen in FIG. 3B, there is reduced valid range of hypothesis (e.g., d_{i′}, d_{j′}, etc.) based upon such processes related to: previous FHS calculations of past frames; a learned filter (e.g., ML-based) based on past frames; simple weighted average analysis of past frames, as well as other input. For example, standard deviation analysis of previous searches and frames can also be implemented. Therefore, the process switches from FHS to RHS, and, in RHS, only a reduced range is searched in based upon probabilistic evaluations of current and past frames. The reduced range via RHS does not only enable lower computation, but also potentially higher accuracy as the range of hypotheses is smaller.

As an example description, RHS may be considered a special case of FHS when the intended search range is reduced from (or a subset of) the full range between min and max disparities. For example, if (min, max)=(0, 192), a range of (64, 128) may be applied for RHS. The reduced range, e.g., (64, 128) may be determined based on historical observations or certain range estimation of disparity likelihoods. For example, if for a prolonged period of time in a particular scene the device has estimated disparities all within a particular reduced range of (64, 128) and the feedback for such estimated disparities have been suitably useable, then likely the next (upcoming) frame is in the same scene and activities and the same reduced range (64, 128) may continue to be a good reduced range to apply for RHS. One benefit for the use of RHS (instead of FHS) is that only a reduced range (and accordingly with a reduced cost and latency) is needed for search. As an example, the FHS for the full range, e.g. (0, 192) may stay constant for a long period time, whereas, the reduced range for RHS may vary from time to time. For example, for some frames a reduced range of (64, 128) may be suitable, while in another set of frames another reduced range of (96, 160) may be suitable. RHS may be applied when there is certain (higher) level of confidence based on recent observations. However, the reduced search range can be enlarged or searching can fall back to FHS.

Based upon the RHS, the final disparity estimation for coordinate pixel (i)-(dᵢ)—can be used for the estimated depth/distance information related to the pixel of the object. Therefore, as shown in FIG. 2, process 200, based on implementing the RHS (block 235), a final disparity estimation (DISP) for coordinate pixel (i)-(dᵢ) is calculated. Accordingly, in one example embodiment, RHS 235 under control of processor 156 may: determine the reduced range of pixels of the image frames of the object to search based upon an analysis of past image frames of the pixels of the object; and, thereafter, select the reduced range of pixels, of the images, of the object, to search.

Continuing with process 200, after the reduced hypothesis searching (RHS) has been performed, processor 156 of device 130 may further implement reduced hypothesis tracking (RHT) of the object. Therefore, at decision block 225, RHT may be selected and process 200 moves to decision block 250 where DD implementations may be selected including Fast Disparity Tracking (FDT) methods that include Open FDT (O-FDT) and Closed FDT (C-FDT), to optimize computation and improve accuracy.

As has been described, the disparity hypothesis (or hypotheses) may be determined based in part on observations in past frames in implementing reduced hypothesis searching (RHS). Further, dynamic depth (DD) methods may employ a (ML-based) learned filter or simple weighted average to derive a dense disparity map D_{hypo} for disparity hypotheses of one hypothesis per coordinate (or pixel) in the map for O-FDT or for disparity hypotheses of two hypotheses per coordinate by adding another dense range map R_{srch} that contains a range per coordinate (or pixel) with a higher bound and a lower bound for C-FDT. As an example, this may be covered by the equation: D_{hypo}=D_{hypo}+R_{srch}—for C-FDT.

In some cases, the R_{srch} may be a pre-defined constant search range per coordinate (or pixel) in terms of a higher bound and a lower bound. In other cases, the R_{srch} may be a dynamically calculated dynamic search range per coordinate (or pixel) based on a scaled value of the estimated standard deviation σᵢ at coordinate (pixel) i.

In some cases, DD may also support multiple continuous search ranges instead of a single continuous search range. A continuous search range is specifiable by a left disparity dᵢ and a right disparity dⱼ, where i<j and i and j are both integer coordinate indices, jointly cover a continuous range of [i, i+1, . . . , j−1, j]. Multiple continuous search ranges are multiple “segmentations” of search ranges, whose pairwise union does not form a single continuous search range.

The disparity hypothesis dᵢ at each coordinate (pixel) i may be derived based on a sliding window of the past disparity estimation outputs. In some cases, a special case of the past disparity estimation outputs is the disparity estimation output of the immediately previous frame.

Therefore, in some aspects, the RHS of DD involves not only a reduced set of disparity hypotheses, but it may dynamically opt for RHT including Fast Disparity Tracking (FDT), an innovative method that tracks the disparity hypotheses at much reduced computation. Therefore, FDT is an alternative method to the standard disparity hypothesis search.

Accordingly, DD may support 2 types of FDT:

Type #1: Opening FDT (O-FDT). In this implementation, given a disparity hypothesis dᵢ at pixel coordinate i, DD searches in 2 opening (or diverging) directions, dᵢ⁺ and dᵢ⁻, towards dᵢ₊₁ and dᵢ₋₁, respectively.

Type #2: Closing FDT (C-FDT). In this implementation, disparity hypotheses dᵢ and dⱼ for i<j, DD tracks in 2 closing (or converging) directions, dᵢ⁺ and dᵢ⁻, towards dᵢ₊₁ and dⱼ₋₁, respectively.

Continuing with the example of process 200, based on RHT selection, at decision block 250 where Fast Disparity Tracking (FDT) methods are selected, Open FDT (O-FDT) may be selected and O-FDT implemented (block 260).

In one example, assuming O-FDT is selected, at decision block 250, process 200 implements O-FDT (block 260). With brief references to FIG. 3C, a description of O-FDT will be provided. As shown in FIG. 3C, in O-FDT 260, based upon a current disparity hypothesis input, disparity hypothesis dᵢ at pixel coordinate i, the DD implementation searches in 2 opening (or diverging) directions, dᵢ⁺ and dᵢ⁻, towards dᵢ₊₁ and dᵢ₋₁, respectively. Further, as shown in FIG. 3C, the search range may cover a search range in a first direction (towards dᵢ₊₂) based on a fixed search range or a standard deviation dependent search range and in a second direction (towards dᵢ₋₂) based on a fixed search range or a standard deviation dependent search range. Additionally, as shown in FIG. 2, additional input may be utilized in the O-FDT implementation including: previous display inputs; multi-modal inputs (in addition to camera inputs), such as- lidar, iToF/dToF, speedometer, Bluetooth, WiFi, 5G, 6G, Ultrasound signals, etc.; standard deviations; search ranges; slow/fast motion; search radiuses; lighting; etc. This is of course a limited list of additional inputs and other types of inputs may be utilized. Based upon the O-FDT implementation, the final disparity estimation for coordinate pixel (i)-(dᵢ)—can be used for the estimated depth/distance information related to the pixel of the object (DISP in FIG. 2).

Continuing with the example of process 200, based on RHT selection, at decision block 250 where Fast Disparity Tracking (FDT) methods are selected, Closed FDT (C-FDT) may be selected and C-FDT implemented (block 270).

In one example, assuming C-FDT is selected, at decision block 250, process 200 implements C-FDT (block 270). With brief references to FIG. 3D, a description of C-FDT will be provided. As shown in FIG. 3D, in C-FDT 260, disparity hypotheses dᵢ and dⱼ for i<j, DD tracks in 2 closing (or converging) directions, dᵢ⁺ and dⱼ⁻, towards dᵢ₊₁ and dⱼ₋₁, respectively (e.g., dᵢ is based on the current disparity hypothesis and dⱼ is based on the current disparity hypothesis). Further, as shown in FIG. 3D, the search range may cover a search range based on a fixed search range or a standard deviation dependent search range. Additionally, as shown in FIG. 2, additional input may be utilized in the C-FDT implementation including: previous display inputs; multi-modal inputs (in addition to camera inputs), such as-lidar, iToF/dToF, speedometer, Bluetooth, WiFi, 5G, 6G, Ultrasound signals, etc.; standard deviations; search ranges; slow/fast motion; search radiuses; lighting; etc. This is of course a limited list of additional inputs and other types of inputs may be utilized. Based upon the C-FDT implementation, the final disparity estimation for coordinate pixel (i)-(dᵢ)—can be used for the estimated depth/distance information related to the pixel of the object (DISP in FIG. 2).

Therefore, in some example aspects, the previous described hypothesis tracking implementations, take a previous or most recent hypothesis and then compare costs only within a much smaller local range close to that of the previous hypothesis. This type of hypothesis tracking usually requires much smaller computation. As previously described, in prior static processing one type of method is always implemented, whereas, by utilizing dynamic switching between an initial hypothesis search and hypothesis tracking smaller computations are enabled, while being able to work well at a times of low confidence and to save power at times of high confidence.

It should be appreciated that O-FDT may be considered to be useful at a time of high confidence and/or at low motion. O-FDT starts with a disparity at each coordinate and search outwards only within local or relatively small ranges on each side of the initial disparity to track the disparity update. In this way, O-FDT can typically enable lower computation while attaining higher accuracy due to high confidence and/or low motion.

It should be appreciated that C-FDT may be considered to be useful at a time of relatively lower confidence or at relatively higher motion. C-FDT starts from a lower bound and a higher bound and starts to search inwards to find the minimum cost. In this way, C-FDT may be considered as a larger tracking method, as C-FDT compares the costs against the reference costs at both the lower and higher boundaries.

Utilizing these previously described techniques, depth estimation can be applied in a wide range of scenarios, including indoor and outdoor, which have very different disparity ranges and characteristics of domains. For example, for an indoor scenario, depths are typically within meters, while for outdoor scenarios, the range can often go more than 10 meters. Given such wide and different characteristics, the previously described techniques of: FHS vs. RHS; hypothesis searching vs. hypothesis tracking; O-FDT vs. C-FDT; dynamic switching; utilizing standard deviations for uncertainty measures-provide both efficiency and accuracy. Also, lighting conditions can often be very different between indoor and outdoor scenarios, which makes the model confidence level potentially impacted. Therefore, utilizing a dynamic switch mechanism in implementing the DD techniques can be beneficial.

Moreover, as will be described in more detail hereafter, aspects relate to DD implementations to support zooming into specific objects, regions, or depth ranges to further enhance efficiency and precision. As will be described, the previously described DD techniques may support “zooming” on particular objects or regions. As examples, the previously described DD techniques may support: Zooming in on one or more particular objects (e.g., a pedestrian on the street, an upcoming car, etc.); Zooming in on one or more particular regions (e.g., a tree, a rock, regions on a table, under a chair, etc.); Zooming in on one or more particular depths of ranges from the camera (e.g., within range of 4~6 meters in front of the car, within range of less than 1 meter to a rock, a book on a table, etc.).

More specifically, when zooming is enabled or triggered, DD identifies and specifies the particular object(s), region(s), and/or the depth value(s) by deriving the corresponding disparities range(s). Once such zooming conditions are derived, DD can perform RHS or RHT with respect to the specified disparity ranges to perform reduced hypothesis searching or tracking, while leaving out other unspecified disparity regions in searching or tracking. This is not only helpful in achieving lower computation, but also potentially higher accuracy due to the reduced range of hypotheses to compete in the derivation and decision through cost minimization.

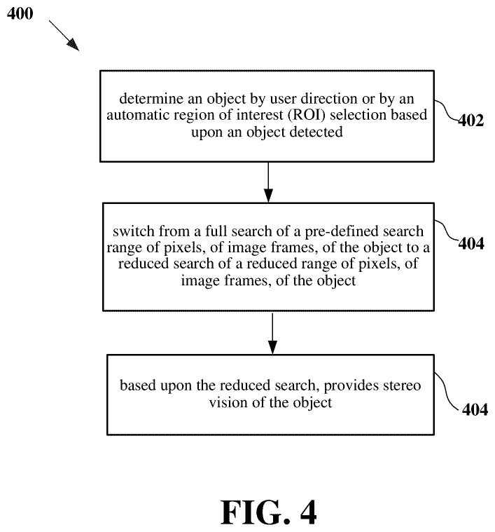

With brief reference to FIG. 4, a flowchart of the previously described method according to one aspect will be described. As previously described, aspects of the disclosure relate to utilizing dynamic stereo depth estimation by dynamically switching between full and reduced searches. At block 402, method 400 determines an object by user direction (e.g., through a user interface by the user) or by an automatic region of interest (ROI) selection based upon an object detected (e.g., by the device itself). At block 404, method 400 switches from a full search of a pre-defined search range of pixels, of image frames, of the object to a reduced search of a reduced range of pixels, of image frames, of the object. At block 406, method 400, based upon the reduced search, provides stereo vision of the object.

Based upon the previously described dynamic depth stereo estimation solution implementations (e.g., referred to as dynamic depth (DD)), limitations of traditional stereo depth estimation algorithms are addressed by switching from a full search to a reduced search. In particular, the DD implementations dynamically switch between a Full-Hypothesis Search (FHS) and a Reduced-Hypothesis Search (RHS) based on probabilistic evaluations of current and past frames. Further, the previously described aspects related to DD implementations also incorporate Fast Disparity Tracking (FDT) methods, including Open FDT (O-FDT) and Closed FDT (C-FDT), to optimize computation and improve accuracy. The FDT methods track the disparity hypotheses with a great reduction in computational costs and is an alternative method to the standard disparity hypothesis search. Moreover, aspects related to DD implementations support zooming into specific objects, regions, or depth ranges to further enhance efficiency and precision. These innovative solutions may leverage machine learning-based filters and dynamic search ranges to provide a more efficient and accurate depth estimation.

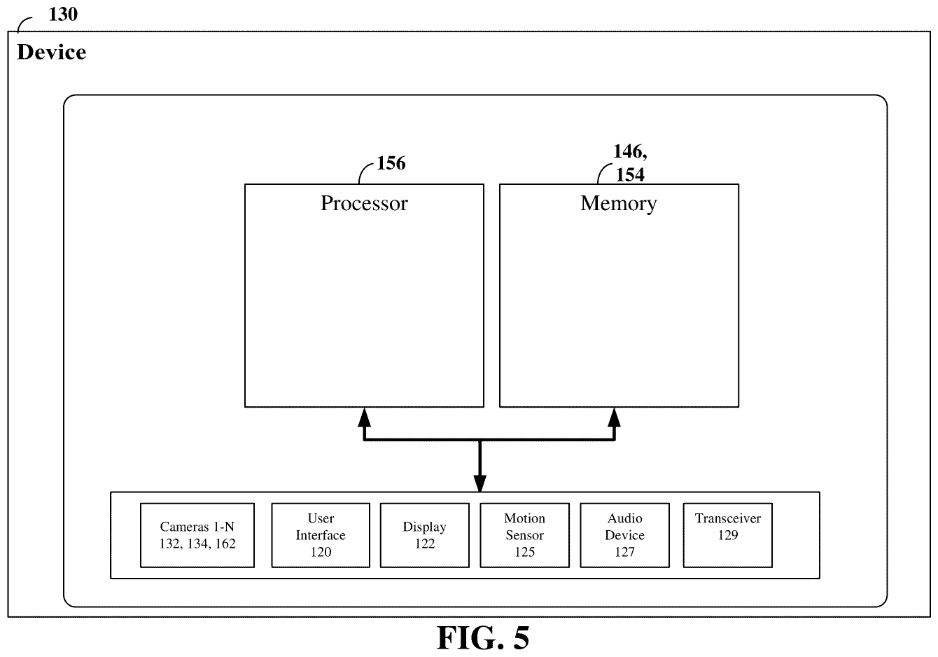

With brief reference to FIG. 5, FIG. 5 is a simplified diagram of FIG. 1. Like FIG. 1, FIG. 5 illustrates device 130 including: processor 156, memories 146,154, and cameras 1-N (132, 134, 162), user interface 120, display 122, transceiver or modem 129, etc. FIG. 5 is a simplified diagram for ease of reference to aid in illustrating particular example implementations described below. As previously described, device 130 may be: a mobile device, a mobile phone, a vehicle, a robot, a stationary Internet of Things (IoT) device, a mobile IoT device, or a security device. However, these devices are just examples and it should be appreciated that device 130 may be any suitable device.

In one example, processor 156 may: determine an object by user direction (e.g., through user interface 120 by the user) or by an automatic region of interest (ROI) selection based upon an object detected (e.g., by the device itself). Further, processor 156 may command the switching from Full-Hypothesis Search (FHS) of a pre-defined search range of pixels, of image frames, of the object (e.g., selected by the user or the automatic ROI) to a reduced search of a reduced range of pixels, of image frames, of the object (e.g., selected by the user or the automatic ROI). For example, processor 156 may first implement a Full-Hypothesis Search (FHS) of a pre-defined search range of pixels, of image frames, of the object, as previously described with reference to FIG. 3A. FHS is typically selected as a first selection, e.g., as first cold start, and when the device is not certain about what specific sub-range of hypotheses to search for. Next, when the device 130 becomes more certain about what specific sub-range to search for, such as, low frame-to-frame variation in motions, then processor 156 may dynamically switch from FHS to RHS. As an example, RHS as part of DD may employ a learned filter (e.g., ML-based) or simple weighted average. For example, processor 156 may first implement a Reduced-Hypothesis Search (FHS) of a pre-defined search range of pixels, of image frames, of the object, as previously described with reference to FIG. 3B. After RHS has been performed, processor 156 of device 130 may further implement reduced hypothesis tracking (RHT) of the object. As previously described, RHT may include Fast Disparity Tracking (FDT) processes that include Open FDT (O-FDT) and Closed FDT (C-FDT). For example, processor 156 may implement Open FDT (O-FDT) described previously with reference to FIG. 3C and Closed FDT (C-FDT) described previously with reference to FIG. 3D.

As has been described, device 130 may be: a mobile device, a mobile phone, a vehicle, a robot, a stationary Internet of Things (IoT) device, a mobile IoT device, or a security device. However, these devices are just examples and it should be appreciated that device 130 may be any suitable device. Further, as has been described, in the user-directed mode a user may select an object by user direction (e.g., a user may select an object through a user interface 120). As another example, in the automatic ROI mode, device 130 may automatically select an object by an ROI. Examples of different types of objects automatically selected by an ROI by device 130 or by a user will be described hereafter.

Various example of device implementations will be hereafter described.

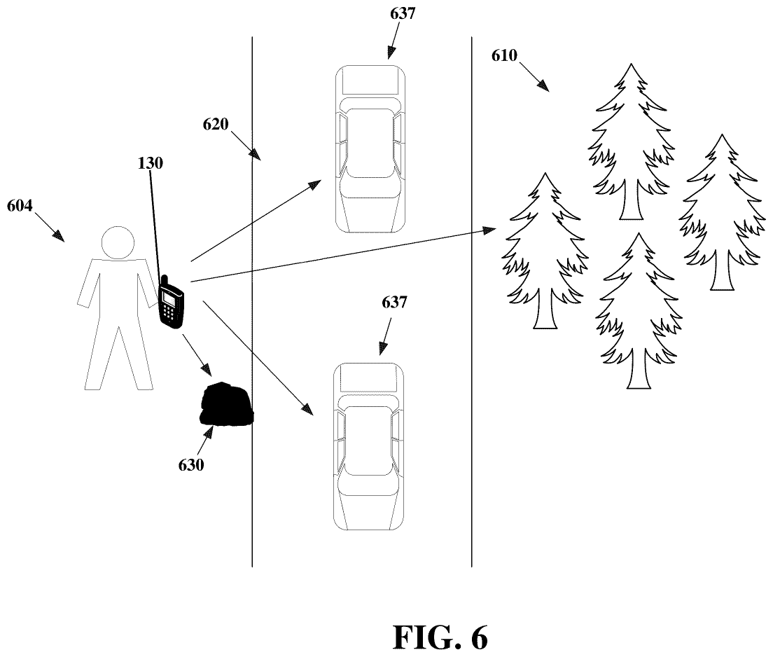

With additional reference to FIG. 6, various example scenarios where device 130 is a mobile device to implement previously described DD techniques will be described. In one example, mobile device 130 is for use by a user by 604. In this example, mobile device 130, will as previously described, include a user interface 120 to receive user input from the user; an audio device 127 to provide audio sound to the user; a transceiver 129 to transmit and receive data via a wireless network. It should be appreciated that this is just one example of a mobile device 103 utilizing previously described components (e.g., FIGS. 1 and 5) and that any suitable mobile device may be utilized. In one example implementation, mobile device 103 under the control of processor 156 may, after a user selects an object and reduced tracking of the object is implemented, processor 156 may be further configured to zoom in the object and provide stereo vision of the object. As will also be described, images unrelated to the object zoomed in on may be removed. Therefore, unrelated regions, backgrounds, foregrounds, etc., may be removed.

In one example implementation, based upon user direction by user 604 through the user interface 120, processor 156 may be configured to command: zooming in on an object based on user direction through the user interface 120; and display the object zoomed in on (e.g., on the display 122). Processor 156 may also command removing images unrelated to the object zoomed in on. In this way, various other regions may be removed.

Various examples will now be described. In one example, user 604 may zoom in on trees 610 across the street 620 via user direction of the user through user interface. For example, user 604 may zoom in on the trees 610 via a touch-screen or the user providing an audio input (e.g., zoom in on the trees). Based upon this, processor 156 may display the trees 610 zoomed in on to provide zoomed vision of trees to the user on the display 122 (e.g., screen on the mobile phone), with various images unrelated to the trees 610 removed (e.g., rock 630, street 620, car 637, signs (not shown, etc.). It should be appreciated that the trees 610 may be at a relatively larger range distance (e.g., 30 meters) whereas closer objects (e.g., car 637) may be removed.

For example, processor 156 may first implement a Full-Hypothesis Search (FHS) of a pre-defined search range of pixels, of image frames, of the trees 610, as previously described with reference to FIG. 3A and processor 156 may then dynamically switch from FHS to RHS as part of zooming. For example, processor 156 may implement a Reduced-Hypothesis Search (RHS) of a pre-defined search range of pixels, of image frames of trees 610, as previously described with reference to FIG. 3B. After RHS has been performed, processor 156 of device 130 may further implement reduced hypothesis tracking (RHT) of the trees. As previously described, RHT may include Fast Disparity Tracking (FDT) processes that include Open FDT (O-FDT) (e.g., FIG. 3C) and Closed FDT (C-FDT) (e.g., FIG. 3D). Based upon these implementations, processor 156 may calculate the stereo depth of one or more trees 610.

In another example, user 604 may zoom in on rock 630 via user direction of the user through user interface. The rock 630 being very close to user 604 (e.g., less than 2 meters). For example, user 604 may zoom in on rock 630 via a touch-screen or the user providing an audio input (e.g., zoom in on the rock). Based upon this, processor 156 may display the rock 630 zoomed in on to provide zoomed display of rock 630 to the user on the display 122 (e.g., screen on the mobile phone), with various images unrelated to the trees 610 removed (e.g., street 620, cars 637, 639, trees 610 signs (not shown, etc.). As previously described, processor 156 may first implement a Full-Hypothesis Search (FHS) of a pre-defined search range of pixels, of image frames, of rock 630, as previously described with reference to FIG. 3A and processor 156 may then dynamically switch from FHS to RHS as part of zooming. For example, processor 156 may implement a Reduced-Hypothesis Search (RHS) of a pre-defined search range of pixels, of image frames of rock 630, as previously described with reference to FIG. 3B. After RHS has been performed, processor 156 of device 130 may further implement reduced hypothesis tracking (RHT) of the rock 630. As previously described, RHT may include Fast Disparity Tracking (FDT) processes that include Open FDT (O-FDT) (e.g., FIG. 3C) and Closed FDT (C-FDT) (e.g., FIG. 3D). Based upon these implementations, processor 156 may calculate the stereo depth of rock 630.

In another example, user 604 may zoom in on a moving car 637 on the street 620 via user direction of the user through user interface (e.g., car 637 shown at two different locations). For example, user 604 may zoom in on moving car 637 via a touch-screen or the user providing an audio input (e.g., zoom in on the car). Based upon this, processor 156 may display the moving car 637 zoomed in on to provide zoomed display of the moving car 637 to the user on the display 122 (e.g., screen on the mobile phone), with various images unrelated to the moving car 637 removed (e.g., rock 630, trees 610, etc.). Therefore, regions at different locations (e.g., background region), such as trees 610 (e.g., 30 meters away) may be removed.

For example, processor 156 may first implement a Full-Hypothesis Search (FHS) of a pre-defined search range of pixels, of image frames, of the moving car 637, as previously described with reference to FIG. 3A and processor 156 may then dynamically switch from FHS to RHS as part of zooming. For example, processor 156 may implement a Reduced-Hypothesis Search (RHS) of a pre-defined search range of pixels, of image frames of moving car 637, as previously described with reference to FIG. 3B. After RHS has been performed, processor 156 of device 130 may further implement reduced hypothesis tracking (RHT) of the moving car 637. As previously described, RHT may include Fast Disparity Tracking (FDT) processes that include Open FDT (O-FDT) (e.g., FIG. 3C) and Closed FDT (C-FDT) (e.g., FIG. 3D). Based upon these implementations, processor 156 may calculate the stereo depth of the moving car 637 and device 130 may track the car for the user, in a very efficient manner.

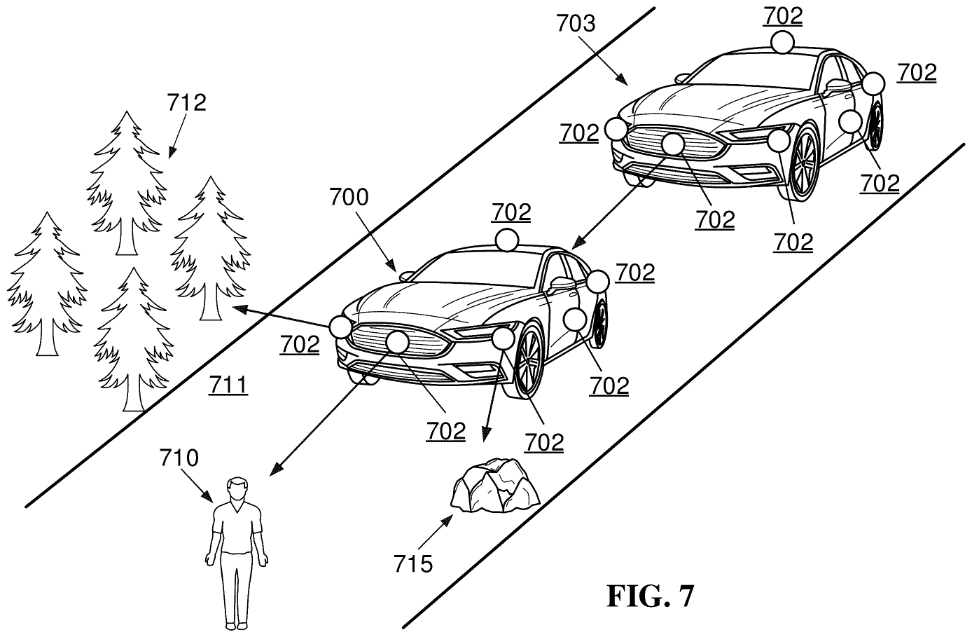

Another set of examples of device implementations will be hereafter described. With additional reference to FIG. 7, various example scenarios where device 130 is a vehicle 700 driving towards an object to implement previously described DD techniques will be described. In one example, vehicle 700 may include various sensors 702 (e.g., cameras) and processor 156 to implement: FHS; RHS; RHT; and after implementing reduced tracking of the object, zooming in on an object to provide zoomed stereo vision of the object. Further, vehicle 700 may include other previously described features, such as: the user interface; display; transceiver; etc. It should be appreciated that the various sensors 702 (e.g., cameras) may be at multiple locations on the vehicle 700.

It should be appreciated that this is just one example of a vehicle 700 utilizing previously described components (e.g., FIGS. 1 and 5) and that any suitable vehicle may be utilized. In one example implementation, vehicle 700 under the control of processor 156 may be configured to: identify an object by an automatic region of interest (ROI) selection by the vehicle 700; and, after implementing reduced tracking of the object, zoom in on the object and provide stereo vision of the object. As will also be described, images unrelated to the object zoomed in on may be removed.

In one example implementation, based upon an object near the vehicle automatically selected by a ROI by the processor 156, after implementing reduced tracking of the object, processor 156 may be configured to command: zooming in on the object to provide stereo vision of the object and to display the object zoomed in on (e.g., on the display 122). Also, processor 156 may also command removing images unrelated to the object zoomed in on. In additional implementations, processor 156 may command stopping the vehicle if it comes within a close pre-defined range of the object.

Various examples will now be described. In one example, vehicle 700 under control of processor 156 may automatically identify trees 712 as ROI and may zoom in on trees 712 on the other side of the street 711. Based upon this, processor 156 may display the trees 610 zoomed in on to provide zoomed display of trees to the user of the vehicle on a display 122 (e.g., screen in the vehicle), with various images unrelated to the trees 712 removed (e.g., street 711, signs (not shown, etc.)).

For example, processor 156 may first implement a Full-Hypothesis Search (FHS) of a pre-defined search range of pixels, of image frames, of the trees 712, as previously described with reference to FIG. 3A and processor 156 may then dynamically switch from FHS to RHS as part of zooming. For example, processor 156 may implement a Reduced-Hypothesis Search (RHS) of a pre-defined search range of pixels, of image frames of trees 712, as previously described with reference to FIG. 3B. After RHS has been performed, processor 156 of vehicle 700 may further implement reduced hypothesis tracking (RHT) of the trees. As previously described, RHT may include Fast Disparity Tracking (FDT) processes that include Open FDT (O-FDT) (e.g., FIG. 3C) and Closed FDT (C-FDT) (e.g., FIG. 3D). Based upon these implementations, processor 156 may also calculate the stereo depth of one or more trees 712 and may display the zoomed in on trees to the driver.

In another example, vehicle 700 under control of processor 156 may automatically identify rock 715 as a ROI and may zoom in on rock 715 that the vehicle could possible run over. Based upon this, processor 156 may display the rock 715 zoomed in on to provide zoomed display of rock 715 to the user of the vehicle on a display 122 (e.g., screen in the vehicle), with various images and regions unrelated to the rock 712 removed (e.g., trees 712, signs (not shown), etc.). For example, processor 156 may first implement a Full-Hypothesis Search (FHS) of a pre-defined search range of pixels, of image frames, of the rock 715, as previously described with reference to FIG. 3A and processor 156 may then dynamically switch from FHS to RHS as part of zooming. For example, processor 156 may implement a Reduced-Hypothesis Search (RHS) of a pre-defined search range of pixels, of image frames of rock 715, as previously described with reference to FIG. 3B. After RHS has been performed, processor 156 of vehicle 700 may further implement reduced hypothesis tracking (RHT) of the rock 715. As previously described, RHT may include Fast Disparity Tracking (FDT) processes that include Open FDT (O-FDT) (e.g., FIG. 3C) and Closed FDT (C-FDT) (e.g., FIG. 3D). Based upon these implementations, processor 156 may also calculate the stereo depth of rock 715. This can alert the driver to avoid rock 715 as vehicle 700 approaches the rock 705 and/or vehicle 700 may be commanded to brake before hitting the rock.

In another example, vehicle 700 under control of processor 156 may automatically identify pedestrian 710 as a ROI and may zoom in on pedestrian 710 that the vehicle could possibly hit. Based upon this, processor 156 may display the pedestrian 710 zoomed in on to provide zoomed display of the pedestrian 710 to the user of the vehicle on a display 122 (e.g., screen in the vehicle), with various images and regions unrelated to the pedestrian 710 removed (e.g., trees 712, rock 715, signs (not shown), etc.) For example, processor 156 may first implement a Full-Hypothesis Search (FHS) of a pre-defined search range of pixels, of image frames, of the pedestrian 710, as previously described with reference to FIG. 3A and processor 156 may then dynamically switch from FHS to RHS as part of zooming. For example, processor 156 may implement a Reduced-Hypothesis Search (RHS) of a pre-defined search range of pixels, of image frames of pedestrian 710, as previously described with reference to FIG. 3B. After RHS has been performed, processor 156 of vehicle 700 may further implement reduced hypothesis tracking (RHT) of the pedestrian 710. As previously described, RHT may include Fast Disparity Tracking (FDT) processes that include Open FDT (O-FDT) (e.g., FIG. 3C) and Closed FDT (C-FDT) (e.g., FIG. 3D). Based upon these implementations, processor 156 may also calculate the stereo depth of the pedestrian 710. The driver may be alerted to avoid pedestrian 710 or the vehicle may be commanded to brake to avoid hitting the pedestrian.

In yet another example, another vehicle 703 (operating with the same components and functions as previously described vehicle 700) under control of processor 156 may automatically identify vehicle 700 as a ROI and may zoom in on vehicle 700 to display and monitor vehicle 700 and possible avoid collision with vehicle 700. Based upon this, processor 156 may display vehicle 700 zoomed in on to provide zoomed display of vehicle 700 to the user of the vehicle 703 on a display 122 (e.g., screen in the vehicle), with various images and regions unrelated to vehicle 700 removed (e.g., trees 712, signs (not shown), etc.). For example, processor 156 may first implement a Full-Hypothesis Search (FHS) of a pre-defined search range of pixels, of image frames, of vehicle 700, as previously described with reference to FIG. 3A and processor 156 may then dynamically switch from FHS to RHS as part of zooming. For example, processor 156 may implement a Reduced-Hypothesis Search (RHS) of a pre-defined search range of pixels, of image frames of vehicle 700, as previously described with reference to FIG. 3B. After RHS has been performed, processor 156 of vehicle 703 may further implement reduced hypothesis tracking (RHT) of vehicle 700. As previously described, RHT may include Fast Disparity Tracking (FDT) processes that include Open FDT (O-FDT) (e.g., FIG. 3C) and Closed FDT (C-FDT) (e.g., FIG. 3D). Based upon these implementations, processor 156 may also calculate the stereo depth of vehicle 700. The driver may be alerted to avoid vehicle 700 or vehicle 703 may be commanded to brake to avoid hitting vehicle 700.

It should be appreciated that by these previous implementations of tracking the object (trees 712, pedestrian 710, rock 715, other vehicle), the vehicle can alert the driver to avoid the object or may automatically brake to avoid the object. It should be appreciated that other images or regions unrelated to the zoomed in object at different distances may be removed.

Therefore, aspects of the disclosure, as have been previously described, utilize dynamic stereo depth estimation by dynamically switching between full and reduced searches in providing stereo vision of an object in a very computationally efficient manner while maintaining high accuracy and further can be used to provide tracking and zooming implementations.

Utilizing these previously described techniques, depth estimation can be applied in a wide range of scenarios which have very different disparity ranges and characteristics of domains. Given such wide and different characteristics, the previously described techniques of: FHS vs. RHS; hypothesis searching vs. hypothesis tracking; O-FDT vs. C-FDT; dynamic switching; utilizing standard deviations for uncertainty measures-provide both efficiency and accuracy. Also, lighting conditions can often be very different between indoor and outdoor scenarios, which makes the model confidence level potentially impacted. Therefore, utilizing a dynamic switch mechanism in implementing the DD techniques can be beneficial.

As previously described, aspects relate to DD implementations to support zooming into specific objects, regions, or depth ranges to further enhance efficiency and precision. The previously described DD techniques support “zooming” in on particular items or regions. As previously described, the DD techniques may support: Zooming in on one or more particular objects (e.g., a pedestrian on the street, trees, a rock, an upcoming car, etc.); Zooming in on one or more particular regions (e.g., trees, upcoming cars, a rock, etc.); Zooming in on one or more particular depths of ranges from the camera (e.g., within range of 4~6 meters in front of the car to a pedestrian, within range of less than 1 meter to a rock, etc.).

As previously described, when zooming is enabled or triggered, DD identifies and specifies the particular object(s), region(s), and/or the depth value(s) by deriving the corresponding disparities range(s). Once such zooming conditions are derived, DD can perform RHS or RHT with respect to the specified disparity ranges to perform reduced hypothesis searching or tracking, while leaving out other unspecified disparity regions in searching or tracking. This is not only helpful in achieving lower computation, but also potentially higher accuracy due to the reduced range of hypotheses to compete in the derivation and decision through cost minimization.

Based upon the previously described dynamic depth stereo estimation solution implementations (e.g., referred to as dynamic depth (DD)), limitations of traditional stereo depth estimation algorithms are addressed by switching from a full search to a reduced search. In particular, the DD implementations dynamically switch between a Full-Hypothesis Search (FHS) and a Reduced-Hypothesis Search (RHS) based on probabilistic evaluations of current and past frames. Further, the previously described aspects related to DD implementations also incorporate Fast Disparity Tracking (FDT) methods, including Open FDT (O-FDT) and Closed FDT (C-FDT), to optimize computation and improve accuracy. The FDT methods track the disparity hypotheses with a great reduction in computational costs and is an alternative method to the standard disparity hypothesis search. Moreover, aspects related to DD implementations support zooming into specific objects, regions, or depth ranges to further enhance efficiency and precision. These innovative solutions may leverage machine learning-based filters and dynamic search ranges to provide a more efficient and accurate depth estimation.

It should be appreciated that the features previously described types of digital video capabilities may be incorporated into a wide range of devices, including mobile devices, mobile phones, vehicles, automatic driving vehicles, XR glasses, always-on sensors, robots, a stationary Internet of Things (IoT) device, a mobile IoT device, security device, digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Also, as has been described, such devices may be implemented in scenarios related to vehicles, mobile devices, security, etc.

Various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as limitations.

The various illustrative logical blocks, modules, and circuits described in connection with the aspects disclosed herein may be implemented or performed with a general purpose processor, a DSP, an ASIC, an FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Various modifications to the described aspects may be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The processes previously described may include additional aspects, such as any single aspect or any combination of aspects described below and/or in connection with one or more other processes described elsewhere herein.

Aspect 1: A device comprising: one or more memories configured to store one or more image frames; and one or more processors coupled to the one or memories, the one or more processors configured to: determine an object by user direction or by an automatic region of interest (ROI) selection; switch from a full search of a pre-defined search range of pixels, of image frames, of the object to a reduced search of a reduced range of pixels, of image frames, of the object; and based upon the reduced search, provide stereo vision of the object.

Aspect 2: The device of aspect 1, further comprising a plurality of cameras, the plurality of cameras configured to capture the one or more images frames.

Aspect 3: The device of any of aspects 1 through 2, wherein, the automatic ROI is defined by at least one of a region, pixel coordinates, disparity ranges, a semantic class, an object instance, a foreground, or a background.

Aspect 4: The device of any of aspects 1 through 3, wherein, the one or more processors are further configured to remove images unrelated to the object.

Aspect 5: The device of any of aspects 1 through 4, wherein, the one or more processors are further configured to: determine the reduced range of pixels of the image frames of the object to search based upon an analysis of past image frames of the pixels of the object; and select the reduced range of pixels, of the image frames, of the object, to search.

Aspect 6: The device of aspect 5, wherein, after the reduced search has been performed, the one or more processors are further configured to implement reduced tracking of the object.

Aspect 7: The device of aspect 6, wherein, to implement reduced tracking of the object, the one or more processors are further configured to determine disparity estimation for each pixel based on past disparity estimates.

Aspect 8: The device of aspect 7, wherein reduced tracking comprises open fixed disparity tracking that is based on a fixed search range outward or a standard deviation dependent search range outward from a current disparity.

Aspect 9: The device of aspect 8, wherein, the one or more processors are further configured to receive at least one additional input related to previous disparity, search range, motion, search radius, or lighting to implement open fixed disparity tracking.

Aspect 10: The device of any of aspects 8 through 9, wherein, the one or more processors are further configured to generate a disparity map based upon a machine learned filter or a weighted average to implement open fixed disparity tracking.

Aspect 11: The device of aspect 6, wherein reduced tracking comprises closed fixed disparity tracking that is based on a fixed search range or a standard deviation dependent search range inward from a maximum level disparity and a minimum level disparity.

Aspect 12: The device of aspect 11, wherein, the one or more processors are further configured to receive at least one additional input related to previous disparity, search range, motion, search radius, or lighting to implement closed fixed disparity tracking.

Aspect 13: The device of any of aspects 11 through 12, wherein, the one or more processors are further configured to generate a disparity map and a dense range map based upon a machine learned filter or a weighted average to implement closed fixed disparity tracking.

Aspect 14: The device of any of aspects 6 through 13, wherein, the device is a mobile device for use by a user, further comprising: a user interface to receive user input from the user; a display to display objects to the user; an audio device to provide audio sound to the user; a transceiver to transmit and receive data; and after implementing reduced tracking of the object, the one or more processors are further configured to: zoom in on the object to provide stereo vision of the zoomed object.

Aspect 15: The device of aspect 14, wherein, based on user direction input of the user through the user interface, the one or more processors are further configured to: zoom in on the object based on the user direction input of the user through the user interface; display the object zoomed in on to provide zoomed stereo vision of the object to the user on the display device; and remove images unrelated to the object zoomed in on.

Aspect 16: The device of any of aspects 6 through 13, wherein, the device is a vehicle driving towards the object, and the one or more processors are configured to: after implementing reduced tracking of the object, zoom in on the object to provide zoomed stereo vision of the object.

Aspect 17: The device of any of aspects 6 through 13, wherein, when the device is a vehicle driving towards the object, the one or more processors are configured to: identify the object by an automatic region of interest (ROI) selection near the vehicle; after implementing reduced tracking of the object, zoom in on the object to provide zoomed stereo vision of the object; and remove images unrelated to the object zoomed in on.

Aspect 18: The device of aspect 17, wherein, the object is identified by user direction.

Aspect 19: A method for providing stereo vision of an object, the method comprising: determining an object by user direction or by an automatic region of interest (ROI) selection; switching from a full search of a pre-defined search range of pixels, of image frames, of the object to a reduced search of a reduced range of pixels, of image frames, of the object; and based upon the reduced search, provide stereo vision of the object.

Aspect 20: A non-transitory computer-readable data storage medium having stored thereon instructions that, when executed, cause one or more processors to: determine an object by user direction or by an automatic region of interest (ROI) selection; switch from a full search of a pre-defined search range of pixels, of image frames, of the object to a reduced search of a reduced range of pixels, of image frames, of the object; and based upon the reduced search, provide stereo vision of the object.

This disclosure describes one or more examples that may be applied independently or in a combined way. It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

One or more of the components, steps, features and/or functions illustrated in FIGS. 1-7 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-7 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

Various examples have been described. These and other examples are within the scope of the following claims.

1. A device comprising:
one or more memories configured to store one or more image frames; and
one or more processors coupled to the one or memories, the one or more processors configured to:
determine an object by user direction or by an automatic region of interest (ROI) selection;
switch from a full search of a pre-defined search range of pixels, of stereo image frames, of the object to a reduced search of a reduced range of pixels, of the stereo image frames, of the object; and
based upon the reduced search, provide stereo vision of the object.

2. The device of claim 1, further comprising a plurality of cameras, the plurality of cameras configured to capture one or more of the stereo image frames.

3. The device of claim 1, wherein, the automatic ROI is defined by at least one of a region, pixel coordinates, disparity ranges, a semantic class, an object instance, a foreground, or a background.

4. The device of claim 1, wherein, the one or more processors are further configured to remove images unrelated to the object.

5. The device of claim 1, wherein the stereo image frames include a current image frame of the pixels of the object and past image frames of the pixels of the object, and wherein, the one or more processors are further configured to:
determine the reduced range of pixels of the stereo image frames of the object to search based upon an analysis of the past image frames of the pixels of the object; and
select the reduced range of pixels, of the stereo image frames, of the object, to search.

6. The device of claim 5, wherein, after the reduced search has been performed, the one or more processors are further configured to implement reduced tracking of the object.

7. The device of claim 6, wherein, to implement the reduced tracking of the object, the one or more processors are further configured to determine disparity estimation for each pixel based on past disparity estimates.

8. The device of claim 7, wherein the reduced tracking comprises open fixed disparity tracking that is based on a fixed search range outward or a standard deviation dependent search range outward from a current disparity.

9. The device of claim 8, wherein, the one or more processors are further configured to receive at least one additional input related to previous disparity, search range, motion, search radius, or lighting to implement the open fixed disparity tracking.

10. The device of claim 8, wherein, the one or more processors are further configured to generate a disparity map based upon a machine learned filter or a weighted average to implement the open fixed disparity tracking.

11. The device of claim 6, wherein the reduced tracking comprises closed fixed disparity tracking that is based on a fixed search range or a standard deviation dependent search range inward from a maximum level disparity and a minimum level disparity.

12. The device of claim 11, wherein, the one or more processors are further configured to receive at least one additional input related to previous disparity, search range, motion, search radius, or lighting to implement the closed fixed disparity tracking.

13. The device of claim 11, wherein, the one or more processors are further configured to generate a disparity map and a dense range map based upon a machine learned filter or a weighted average to implement the closed fixed disparity tracking.

14. The device of claim 6, wherein, the device is a mobile device for use by a user, further comprising:
a user interface to receive user input from the user;
a display to display objects to the user;
an audio device to provide audio sound to the user;
a transceiver to transmit and receive data; and
after implementing the reduced tracking of the object, the one or more processors are further configured to: zoom in on the object to provide stereo vision of the zoomed object.

15. The device of claim 14, wherein, based on user direction input of the user through the user interface, the one or more processors are further configured to:
zoom in on the object based on the user direction input of the user through the user interface;
display the object zoomed in on to provide zoomed stereo vision of the object to the user on the display device; and
remove images unrelated to the object zoomed in on.

16. The device of claim 6, wherein, the device is a vehicle driving towards the object, and the one or more processors are configured to: after implementing the reduced tracking of the object, zoom in on the object to provide zoomed stereo vision of the object.

17. The device of claim 6, wherein, when the device is a vehicle driving towards the object, the one or more processors are configured to:
identify the object by an automatic region of interest (ROI) selection near the vehicle;
after implementing the reduced tracking of the object, zoom in on the object to provide zoomed stereo vision of the object; and
remove images unrelated to the object zoomed in on.

18. The device of claim 1, wherein the full search is a full hypothesis search and the reduced search is a reduced hypothesis search.

19. A method for providing stereo vision of an object, the method comprising:
determining an object by user direction or by an automatic region of interest (ROI) selection;
switching from a full search of a pre-defined search range of pixels, of stereo image frames, of the object to a reduced search of a reduced range of pixels, of the stereo image frames, of the object; and
based upon the reduced search, provide stereo vision of the object.

20. A non-transitory computer-readable data storage medium having stored thereon instructions that, when executed, cause one or more processors to:
determine an object by user direction or by an automatic region of interest (ROI) selection;
switch from a full search of a pre-defined search range of pixels, of stereo image frames, of the object to a reduced search of a reduced range of pixels, of the stereo image frames, of the object; and
based upon the reduced search, provide stereo vision of the object.
